(19) United States
(12) Patent Application Publication
(10) Pub. No.: US 2024/0406809 A1
(43) Pub. Date: Dec. 5, 2024

(54) HANDOVER CONTROL

(71) Applicant: NOKIA SOLUTIONS AND NETWORKS OY, Espoo (FI)

(72) Inventors: Sina KHATIBI, Munich (DE); Umur KARABULUT, Munich (DE); Janne ALI-TOLPPA, Pirkkala (FI); Anna PANTELIDOU, Massy (FR); Teemu Mikael VEIJALAINEN, Helsinki (FI)

(21) Appl. No.: 18/690,868

(22) PCT Filed: Sep. 17, 2021
(86) PCT No.: PCT/EP2021/075675

§ 371 Date: Mar. 11, 2024

(51) Int. Cl. H04W 36/00; H04W 24/02; H04W 36/30

(52) U.S. Cl. CPC H04W 36/0058; H04W 24/02; H04W 36/302

(57) ABSTRACT

Apparatuses and methods for handover control are disclosed. Handover information reports are received from user equipment and a qualitative handover information report for input to a handover optimizer function is generated on the reports. The generating includes mapping failure cause information in the received handover information reports to sets of qualified failure types based on the extend of the failure causes. The qualitative handover information report including information of the generated sets of qualified failure types is signalled to the handover optimizer function. At least one handover parameter can be controlled based on the aggregated information of the sets of qualified failure types.

### FIELD

The present disclosure relates to methods, apparatuses and computer program products for handover control in a mobile communication system.

### BACKGROUND

In a mobile or wireless communication system at least a part of a communications occurs over a wireless or radio link. Mobile communication devices such as mobile user or terminal devices can communicate via access points of a mobile communication system. Mobility is provided by a feature known as handover where a mobile device can continue communications via an access point to communications via another access point. An access point is typically provided by a node such as a base station. A mobile communication device is often referred to as user equipment (UE) or user device.

The mobile device and the access points are provided with appropriate wireless receiving and transmitting apparatus for enabling the communications. Communications may comprise, for example, communication of data for carrying communications such as voice, video, electronic mail (email), text message, multimedia and/or content data and so on. Non-limiting examples of services provided comprise two-way or multi-way calls, data communication, multimedia services and access to a data network system, such as the Internet. Examples of wireless systems comprise public land mobile networks (PLMN), satellite-based communication systems and different wireless local networks, for example wireless local area networks (WLAN).

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called fifth generation (5G) or New Radio (NR) networks. 5G is being standardized by the 3rd Generation Partnership Project (3GPP). The successive versions of the standard are known as Releases (Rel).

### SUMMARY

In accordance with an aspect there is provided an apparatus for handover control in a mobile communication system, the apparatus comprising at least one processor and at least one memory including a computer program code, the at least one memory and computer program code configured to, with the at least one processor, cause the apparatus at least to:
receive handover information reports from user equipment,
generate a qualitative handover information report for input to a handover optimizer function, the generating comprising mapping failure cause information in the received handover information reports to sets of qualified failure types based on the extend of the failure causes, and
send the qualitative handover information report comprising information of the generated sets of qualified failure types to the handover optimizer function.

According to an aspect there is provided a method for handover control in a mobile communication system, the method comprising
receiving handover information reports from user equipment,
generating a qualitative handover information report for input to a handover optimizer function, the generating comprising mapping failure cause information in the received handover information reports to sets of qualified failure types based on the extend of the failure causes, and
sending the generated qualitative handover information report comprising information of the sets of qualified failure types to the handover optimizer function.

According to another aspect there is provided an apparatus for a handover optimizer function in a mobile communication system, the apparatus comprising at least one processor and at least one memory including a computer program code, the at least one memory and computer program code configured to, with the at least one processor, cause the apparatus at least to:
receive a qualitative handover information report comprising aggregated information of sets of qualified failure types mapped from handover information reports from user equipment based on the extend of failure causes, and
control at least one handover parameter based on the aggregated information of the sets of qualified failure types.

According to an aspect there is provided a method for handover control in a mobile communication system, the method comprising:
receiving in a handover optimizer function a qualitative handover information report comprising aggregated information of sets of qualified failure types mapped from handover information reports from user equipment based on the extend of failure causes, and
controlling at least one handover parameter based on the aggregated information of the sets of qualified failure types.

In accordance with a more specific aspect the sets of qualified failure types categorize the failure causes into too late and very too late handover initiations, and/or too early and very too early handover initiations, and/or ping-pong and long ping-pong handovers.

Handover information reports may comprise information of successful handovers. Handover information reports may comprise radio link failure reports and successful handover reports. Handover information reports may comprise information of key performance indicators.

Separate sets of qualified failure types may be defined for inter random access network handover types and intra random access network handover types.

Mapping of failure cause information to sets of qualified failure types may be dynamically changed.

Fuzzy membership functions may be used for the mapping. The membership functions can be defined by the optimizer function. The optimizer function can provide multiple sets of memberships functions. The optimizer function can update the memberships functions.

Root-cause analysis and fuzzification may be provided in at least one base station. Qualitative handover information report comprising information of the sets of qualified failure types can be signalled from the at least one base station into the handover optimizer function.

Root-cause analysis, fuzzification and optimization may be provided by the optimizer function.

An optimizer function may be hosted in a base station.

An optimizer function may comprise a rule based fuzzy optimizer.

An optimizer function may comprise a deep reinforcement learning fuzzy optimizer.

Means for implementing the herein disclosed operations and functions can also be provided.

A computer software product embodying at least a part of the herein described functions may also be provided. In accordance with an aspect a computer program comprises instructions for performing at least one of the methods described herein. A non-transitory computer readable medium including computer program code configured to cause an apparatus to perform herein described methods may be provided.

### BRIEF DESCRIPTION OF DRAWINGS

Some aspects will now be described in further detail, by way of example only, with reference to the following examples and accompanying drawings, in which:

FIG. 1 illustrates an example of a communication system where the invention can be practiced;

FIG. 2 shows an example of control apparatus;

FIG. 3 shows an example of handover flowchart;

FIGS. 4 and 5 are flowcharts according to certain examples;

FIGS. 6A, 6B and 6C show possible implementation scenarios;

FIGS. 7, 8 and 9 are signaling flow charts according to certain examples;

FIG. 10 illustrates possible memberships functions in time;

FIGS. 11 and 12 are example of the optimizers; and

FIG. 13 is an example of an interface arrangement.

### DETAILED DESCRIPTION OF EXAMPLES

The following description gives an exemplifying description of some possibilities to practise the invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

Mobile communication systems provide wireless communications to devices connected therein. Typically, an access point such as a base station is provided for enabling the communications. A handover of a mobile device can be performed from an access point to the other. In the following, different scenarios will be described using, as an example of an access architecture, a 3GPP fifth generation (5G) radio access architecture. However, embodiments are not necessarily limited to such an architecture. Some examples of possible other systems are the universal mobile telecommunications system (UMTS) radio access network (UTRAN or E-UTRAN), long term evolution (LTE), LTE-A (LTE advanced), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS) or any combination and further development thereof.

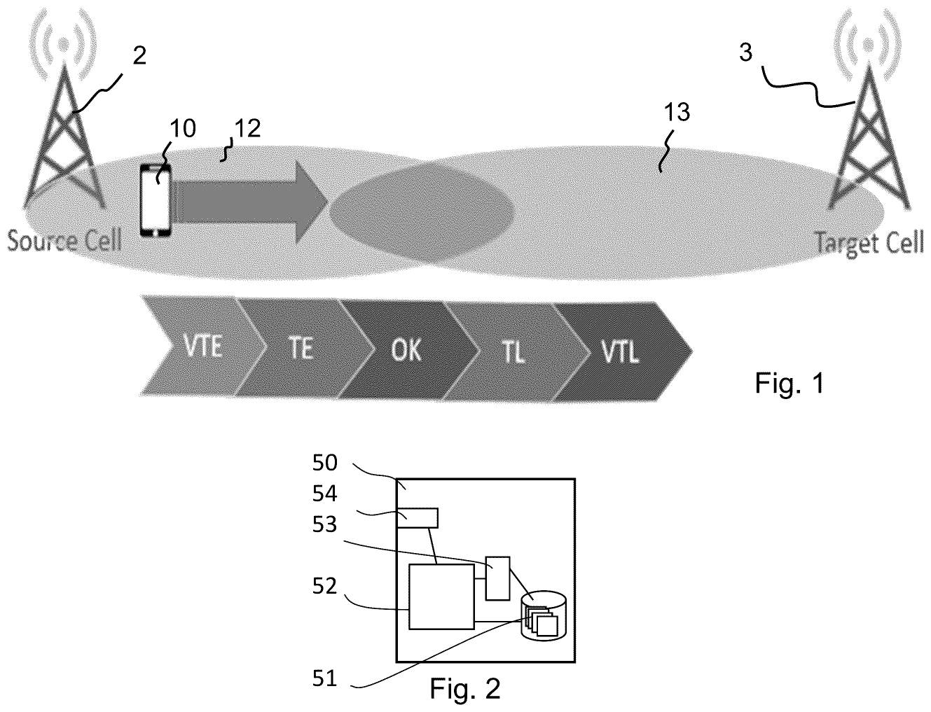

FIG. 1 shows a wireless system 1 comprising two radio access points, or access nodes 2 and 3. A radio access point can comprise a base station. A base station may provide one or more cells 12, 13, and a mobile device 10 may be attached to one of the cells. An access point can comprise any node that can transmit/receive radio signals. For example, a TRP, a 3GPP 5G base station such as gNB, eNB, a user device such as a UE and so forth may provide an access point.

The access points are connected to a wider communication system (not shown for clarity). The communication system can comprise a number of elements. For example, a 5G based system may comprise a 5G radio access network (5GRAN) or next generation radio access network (NG-RAN), a 5G core network (5GC), one or more application functions (AF) and one or more data networks (DN). The 5G-RAN may comprise one or more gNodeB (gNB) or one or more gNodeB (gNB) distributed unit functions connected to one or more gNodeB (gNB) centralized unit functions. The 5GC may also comprise entities such as Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); Session Management Function (SMF) and so on.

The mobile device 10 may be any suitable communications device adapted for wireless communications. A wireless communication device/user equipment may be provided by any device capable of sending and receiving radio signals. Non-limiting examples comprise a mobile station (MS) (e.g., a mobile device such as a mobile phone or what is known as a ‘smart phone’), a computer provided with a wireless interface card or other wireless interface facility (e.g., USB dongle), personal data assistant (PDA) or a tablet provided with wireless communication capabilities, machine-type communications (MTC) devices, Internet of Things (IoT) type communications devices or any combinations of these or the like. The device may be provided as part of another device. The device may receive signals over an air or radio interface via appropriate apparatus for receiving and may transmit signals via appropriate apparatus for transmitting radio signals. The communications can occur via multiple paths. To enable MIMO type communications devices 10 and 12 can be provided with multiantenna elements.

A device such as the access point 2 or 3, and the device 10 is provided with data processing apparatus comprising at least one processor and at least one memory. FIG. 2 shows an example of a data processing apparatus 50 comprising processor(s) 52, 53 and memory or memories 51. FIG. 2 further shows internal connections between the elements of the apparatus and an interface for connecting the data processing apparatus to other components of the device. The at least one memory may comprise at least one ROM and/or at least one RAM. The communications device may comprise other possible components for use in software and hardware aided execution of tasks it is designed to perform, including control of access to and communications with access systems and other communications devices, and implementing the herein described features of handover. The at least one processor can be coupled to the at least one memory. The at least one processor may be configured to execute an appropriate software code to implement one or more of the following aspects. The software code may be stored in the at least one memory, for example in the at least one ROM.

FIG. 1 shows the mobile device 10 being located in the service area of a cell 12 provided by the radio access point 2. It is noted that an access point such as a base station can provide multiple cells. The arrow indicates that the mobile device 10 is moving towards a cell 13 provided by the access point 3. The movement causes initiation of preparations for handover. For the purposes of illustrating better the handover the cell 12 can be called a source cell and the cell 13 a target cell.

The following describes in more detail certain aspects and issues in relation to handovers. Certain detailed illustrative examples for use of information in handover (HO) related reports, such as reports comprising Key Performance Indicators (KPIs) for optimizing mobile communications are also given. The non-limiting illustrative examples relate to optimization of Mobility Robustness Optimization (MRO) in cellular mobile communications. MRO algorithms are used for optimizing mobility parameters to improve mobility performance, e.g., minimize mobility-related failures and unnecessary handovers. A common approach in MRO algorithms is to optimize the Cell Individual Offset (CIO) and Time-to-Trigger (TTT) which are parameters in controlling handover (HO) procedure initiation. The network can control the handover procedure between any cell pair in the network by defining different CIO and TTT values. Different CIO and TTT configurations are advantageously used, for example, for mobile terminals with different speeds. The faster the mobile terminals move, the sooner the handover procedure must be started. The difference is speeds can be addressed by either increasing the CIO (i.e., the offset between the measured signal power of the serving cell and the target cell) or decreasing the TTT (i.e., the interval, during which the trigger requirement is fulfilled). In contrast, in the cell boundaries dominated by slowly moving mobile terminals, the handover procedures are started relatively later by choosing the lower values for the CIO or higher TTT. Changing the CIOs rather than TTTs is currently more commonly used approach.

The speed of the mobile terminals in handover is necessarily not the only criteria to be taken into account. Slow mobile terminals may also be at risk when moving through areas with significant propagation changes (e.g., a successful handover may require an earlier handover, very steep shadowing slopes may cause problems etc.). Fast mobile terminals may not be at such a risk when moving through areas with little propagation changes (e.g., flat shadowing slopes). Hence, even if velocity could be instantaneously estimated with enough accuracy (which is a challenging if not even an impossible task), velocity-based methods would not always react correctly. Nevertheless, the example of speed is used in the following to illustrate the concept with notion that “slow” can be understood to refer to uncritical terminals which are not under failure risk but may still suffer Ping-Pongs, and “fast” can be understood to refer to a critical terminal which is at failure risk.

shows the baseline HO procedure in accordance with current 5G standard. The access nodes, termed gNBs in 5G, can mutually exchange information via an Xn interface. The information can include a radio link failure (RLF) report used to generate KPIs, e.g., “too early handover”, “too late handover”, “handover to wrong cell” and “Ping-Pong handover”. A list of KPIs is specified in 3GPP TS 28.522 v16.0.0. The KPIs can be acquired by an optimizer function. An optimizer function can be implemented either inside the gNBs or outside in more central network entities. Examples of these include Operation, Administration and Maintenance (OAM), Near Real-time RIC (Radio Access Network Intelligent Controller), or AI/ML entities. The optimizer function uses the KPIs to optimize certain parameters such as the CIO for every cell pair.

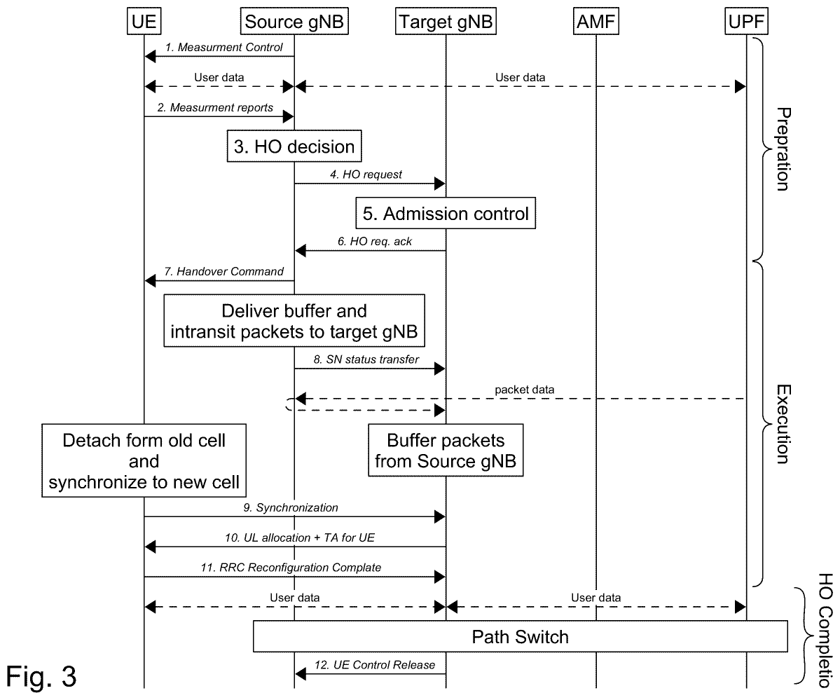

A successful HO requires success in all of the sequences. Conditional HO (CHO) has enabled decoupling the preparation phase from the execution phase. Steps 1 to 7 of FIG. 3 are identical to the legacy handover. A configured event triggers the UE to send a measurement report. Based on this report, the source node can prepare one or more target cells in the same target node, or multiple target nodes for the (conditional) handover (CHO Request+CHO Request Acknowledge) and then sends an RRC (Radio Resource Control) Reconfiguration.

A handover (HO) can either be successfully performed or fail. The mobility-related failures are currently classified into four categories: too late (TL), too early (TE), ping-pong (PP), and Wrong Cell (WC) handovers. Too early (TE) handover happens when the UE handovers to target cell before the link quality of the target cell is good enough. In one example, when an entry condition has been met the TTT timer expires and UE performs the handover procedure. However, shortly after the handover, a Radio Link Failure (RLF) occurs. To avoid this the handover procedure should have started later. Hence, the MRO reduces the related CIO value. Another example of a too early initiated handover is the expiry of timer T304, also called “Handover Failure”. This happens when the target cell is not good enough so that even the Random Access (RACH) fails. Too late (TL) handover happens when either the UE did not even send out a measurement report (e.g., since the TTT timer did not expire before the RLF) or the measurement report or the handover command got lost due to degrading channel conditions, and thus the UE has not started the handover procedure. The solution for eliminating these failures is to start the handover relatively sooner, and to achieve this the MRO can increase the related CIO. Ping-pong (PP) handovers failure refers to cases where the UE hands over to the target cell but shortly after has to handover back to the source cell. Wrong cell (WC) handover failure is where a radio link failure occurs in the target cell shortly after a handover has been completed, and the UE attempts to re-establish its radio link in a cell which is neither the source cell nor the target cell. Alternatively, timer T304 expires during the handover procedure (i.e., “Handover failure”), and the UE attempts to re-establish its radio link in a cell which is neither the source cell nor the target cell.

Occurrence of these failures can be registered by HO failure counters. The HO failure counters are arranged per each failure type. The current HO failure counters only indicate roughly if the HO was initiated too early or too late. The Key Performance Indicator (KPI) counts of events in each category are binary information and therefore cannot provide any qualitative information on the severity of the failure, e.g., how accurate or how far the HO parameters were from the optimal values. Mobility algorithms such as MRO can then only optimize the handover parameters based on such rough binary information by introducing small changes to the parameters and observe how the number of failures in each category develops, and if it has improved.

Mobility optimization algorithms operate on aggregated data and a number of handover events is used to get statistically meaningful feedback for the mobility parameter reconfigurations. In situations, where the mobility patterns change over time, the algorithm may converge slower than the mobility behavior changes in reality. Because of this the algorithm may not to converge as it should.

In the below described examples qualitative information descriptive of the extend of causes of the handover failures is generated from handover related reports received from mobile devices and used as input to the optimizer function. Qualitative handover information can be used to improve the optimization procedure both concerning accuracy and convergence rate. For example, qualitative handover information can be used to adjust the step size of mobility parameter re-configurations. Mobile devices moving from one cell to another can provide information of the extend of the causes of the failures in reports such as the radio link failure (RLF) reports and successful HO reports. The reported qualitative information of the extend of the failures can then be used in mobility information.

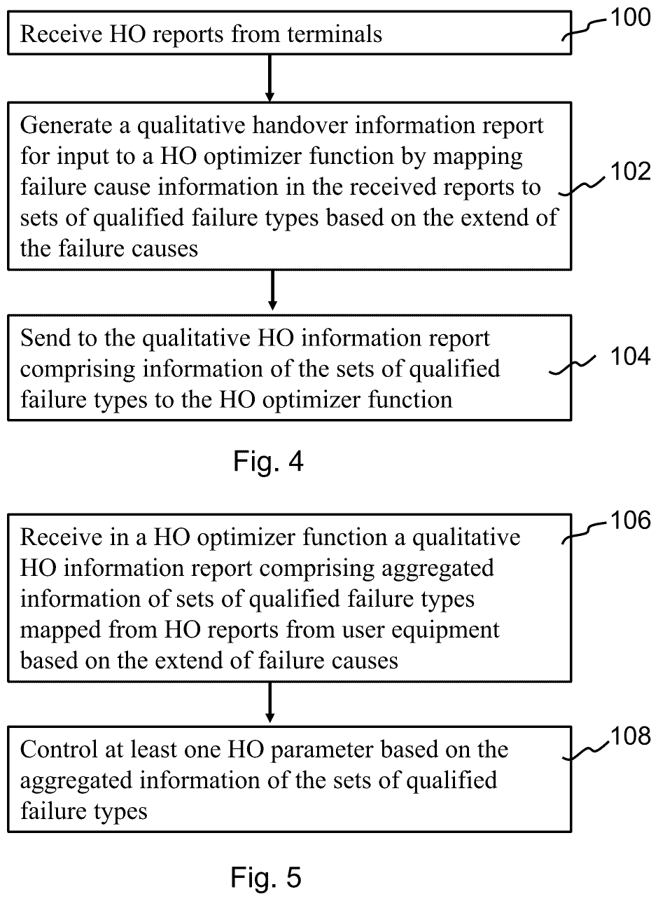

FIG. 4 shows a flowchart in accordance with an example for generation of input information. In the shown method for handover control in a mobile communication system handover information reports are received at 100 from user equipment. A qualitative handover information report can then be generated at 102 for input to a handover optimizer function. The generating comprises mapping failure cause information in the received handover information reports to sets of qualified failure types based on the extend of the failure causes. Examples for the mapping are given below. The generated qualitative handover information report comprising information of the sets of qualified failure types is then signaled at 104 to the handover optimizer function.

FIG. 5 shows a flowchart for a method for handover control in an optimizer function. In the method the handover optimizer function received at 106 a qualitative handover information report comprising aggregated information of sets of qualified failure types mapped from handover information reports from user equipment based on the extend of failure causes. At least one handover parameter can then be controller at 108 based on the received aggregated information of the sets of qualified failure types.

The sets of qualified failure types may be arranged to categorize the failure causes. For example, causes can be categorized into too late and very too late handover initiations, and/or too early and very too early handover initiations, and/or ping-pong and long ping-pong handovers. FIG. 1 shows an illustrative example where increased number of mobility counters is provided such that there is a counter for Very Too-Late (VTL), Too-Late (TL), successful (OK), Too-Early (TE), Very Too-Early (VTE), Ping-Pong (PP), and Long PP (LPP).

The sets of qualified failure types can be further defined for inter random access network (RAN) handover types and intra random access network (RAN) handover types.

The mapping of failure cause information to sets of qualified failure types can be dynamically changed over time. Fuzzification of the information can be provided before input into an optimizer function and/or during the optimizing.

Information regarding HO procedures, either successful or failed ones, and the causes of failures can be aggregated into more qualitative mobility indicators than just the generic type counters for successful, too late (TL), too early (TE) and ping-pong (PP) handovers. Having qualitative information of the causes can be used to improve the optimization procedure both concerning accuracy and convergence rate. Such information can be obtained, for example, from the Key Performance Indicators (KPI) in the report from the mobile terminal devices/UEs. For example, the qualitative information can be used to adjust the step size of the mobility parameter re-configurations.

Qualitative information per mobile terminal/UE is available in the base states. Information available from the base states can be included in reports of UE mobility events to the optimizer function. In the below examples this information is used in mobility control. Aggregation of information received from a plurality of terminal devices improves scalability. Aggregated qualitive information from a number of terminals can be arranged and input for handover optimizer function. The optimizer can be arranged to be able to provide more detailed analysis of the provided qualitative data than just determine if the handover was too-late or too-early by means of adapting of artificial intelligence and machine learning (AI/ML) based techniques to design a fuzzy or AI-based optimizer function that makes use of this information.

Fuzzy control approach can be used in some examples in input for the MRO. A dynamic aggregate approach operated in base stations can map the information available in the RLFs and successful HO reports based on fundamental principles of fuzzification concepts. Signaling between the optimizer function and the base station(s) can be provided to dynamically update the fuzzification membership functions (MFs) and collect fuzzy KPIs. In accordance with a possibility three functions can be provided to implement this.

In accordance with an example the different failure types are further divided into subclasses defining the extend of the failure causes, i.e., severity of the failure. The severity can be expressed as a degree of scale low and high (e.g., very low and very high) rather just having one generic failure type. For instance, failures due to late start of the HO can be divided into very too-late, where the handover should have started relatively much sooner and too-late for the failure causes. Both of these could have been prevented if the HO would have started sooner but the timing would have been different. The PP counters can also be classified, for example, to PP cases which happened during shorter interval of T_pp and longer interval of T_Lpp.

It is also possible to have more than two categories. For example, counters for medium categories can be provided.

FIG. 1 illustrates mapping of HO events to counters for VTE, TE, OK, TL, and VTL events. The events are associated with the UE position in the example scenario for better illustration but this is not necessarily always the case in real life. In the example, if the UE initiates handover towards target cell when it is too far from it, the handover can fail in which case it can be classified as a VTE handover failure. If the handover is initiated when the UE is too far from the source cell, the handover signaling with the source cell can fail and that can lead to a handover failure which classified as VTL handover failure.

These counters can be defined for inter-RAN HO and intra-RAN HO separately.

Failure mapping tables may be provided to implement the mapping. A mapping function in the network can define a mapping between the failure type to a failure class. The mapping can be static (i.e., defined only once) or dynamic (i.e., changes during run-time). The root cause analysis can involve more refined classes and can be based on fuzzy memberships instead of simple counters per class/binary memberships.

Membership functions (MFs) can be used for the fuzzification. The network can optionally define MFs as a part of the failure mapping table. The mapping failure information can be extended to granular failure classes from binary (i.e., “The failure belongs to this failure class” or “The failure does not belong to this failure class”) to fuzzy membership (i.e., The failure with membership degree of x belongs to this failure class). The design of a fuzzy logic controller can comprise defining a fuzzy set and defining the MFs. Examples for this are give later in this specification.

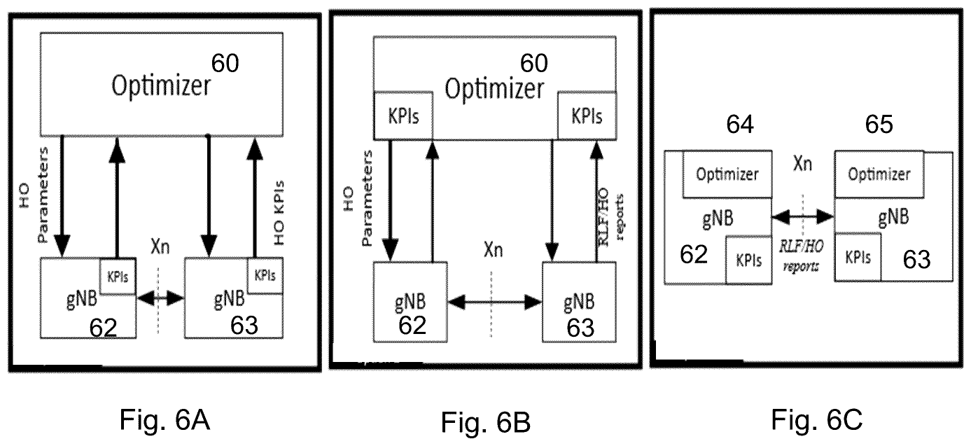

FIGS. 6A, 6B and 6C are examples for three different implementation scenarios. In FIG. 6A base stations provided by 5G gNBs 62, 63 use the Xn interface to transfer RLF/HO reports. The root-cause analysis and fuzzification are processed in the gNBs. The HO KPIs described above are transferred to an optimizer function 60. The optimizer function may be placed in a network entity such as, for example, in near-RT RIC, OAM, edge-cloud, or central cloud.

FIG. 6B shows a scenario where the gNBs 62, 63 transfer the RLF/HO reports to the optimizer function 60. The optimizer function may be placed, e.g., in near RT RIC, edge-cloud, OAM, or central cloud. The root-cause analysis, fuzzification, and optimization can then be provided in the optimizer function 60.

In the scenario of Figure C optimizer functions 64, 65 are hosted in a respective gNB (gNB-CU) 62, 63. The optimization, fuzzification, and root-cause analysis happen in the gNBs.

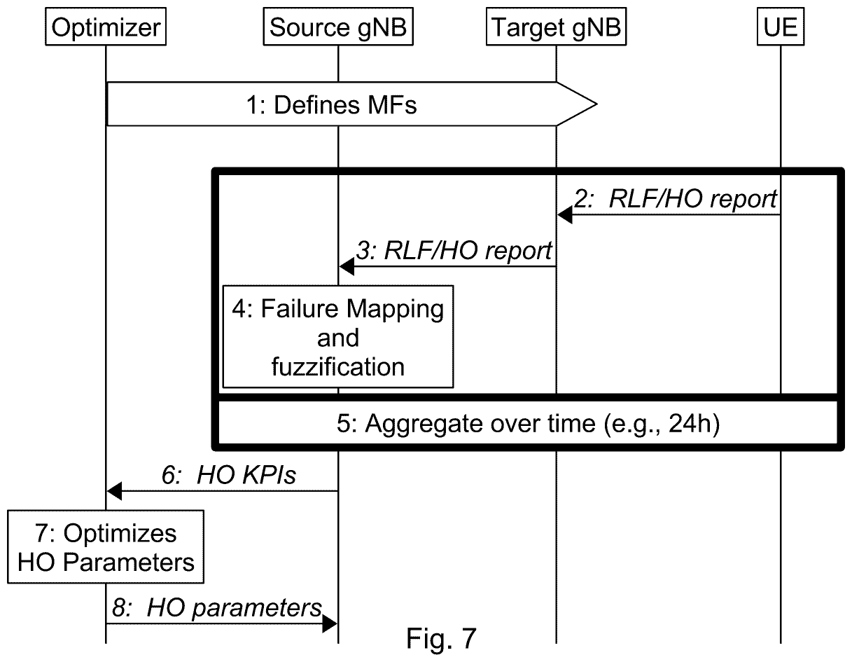

FIG. 6A approach may have the advantage in lower signaling load in the networks that the other examples. It may also be considered an advantageous approach in view of the required computational resources. The following explains implementation detail of FIG. 6A option in more detail, with reference also to the signaling flowcharts of FIGS. 7, 8 and 9.

FIG. 7 presents an approach where an optimizer provides gNBs with the MF definitions. In the flow:
1. The optimizer provides the gNBs with a mapping table and the MFs,
2. The UEs moving from the source gNB to the target gNB provides the target gNB with a RLF report in case of failure and a HO report in case of successful HO.
3. The target gNB forwards the RLF/HO report to the source gNB.
4. The source gNB maps the failures and performs fuzzification of the information,
5. The gNBs aggregate KPIs over the time,
6. The gNBs provide reports of aggregated information to the optimizer,
7. The optimizer runs the algorithms, and
8. The optimizer provides the new HO parameters.

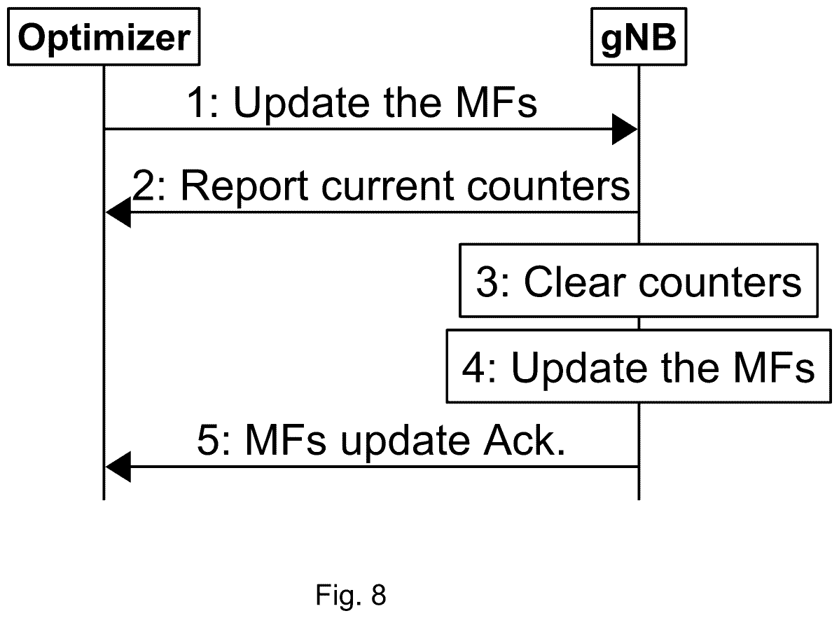

FIG. 8 shows an example where the optimizer may update the MFs to adapt to the network changes and/or to provide fine tuning. In this case:
1. The optimizer sends the updated MFs to the gNB(s),
2. The gNB first reports the current static (calculated with former MFs),
3. clear the counters,
4. The gNB updates the MFS,
5. The gNB sends update acknowledgment so that the optimizer knows any report from the gNB from this point is calculated using the new MFs.

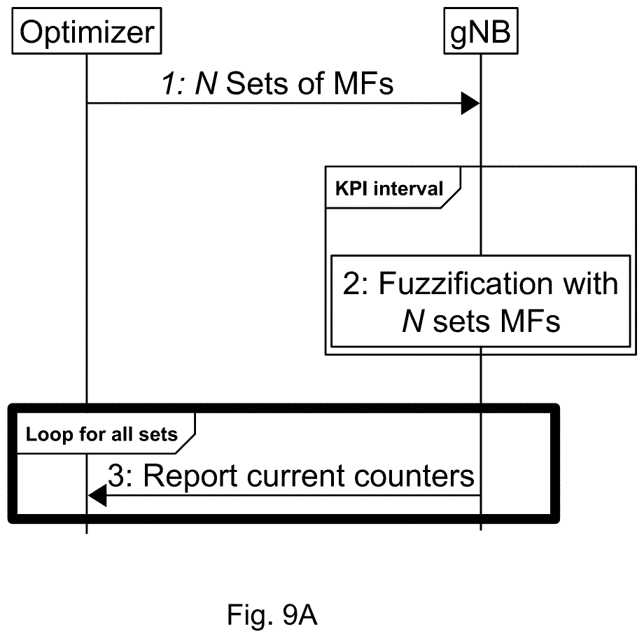

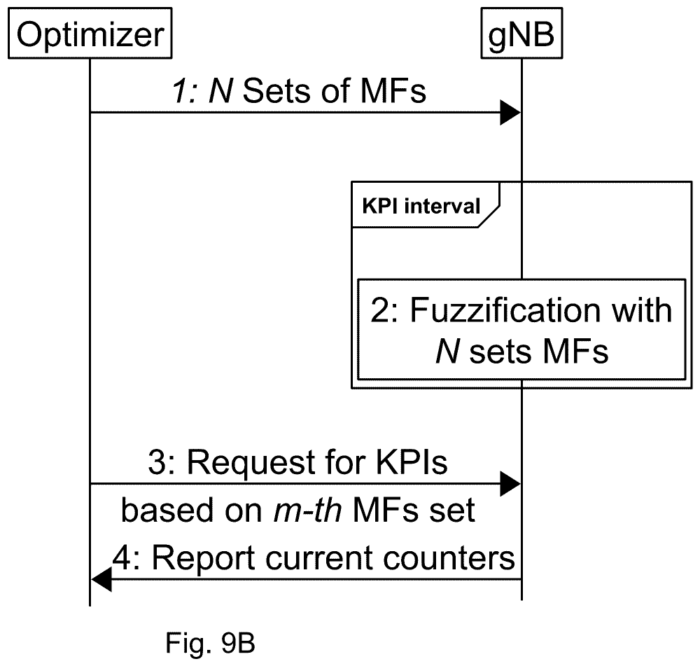

FIGS. 9A and B show examples where the optimizer may provide multiple versions (sets) of MFs to the gNBs. For example, the optimizer may provide multiple sets of MFs to the gNBs to be used dynamically in the future. The gNBs can then perform fuzzification using each set separately.

FIG. 9A shows how a gNB receives N sets of MFs in stage 1. The fuzzification takes place using all the N sets at 2. The gNB can then report all the fuzzy KPIs by message 3 using all the sets, i.e., the report contains multiple sets of KPIs. FIG. 9B shows how, in the reporting time, the optimizer may request at stage 3 fuzzification result of only one, or selected ones of the MFs sets. A request may be made to a subset or all MF sets. The counters of the indicated sets are returned by message 4.

The optimizer can defining failure mapping tables. For example, the optimizer defines the mapping from the event (i.e., failure type) to the set. The table below presents an example mapping of failure types to different sets/counters.

| Failure | Set/ | |
|---|---|---|
| Type | Counter | Description |
| F0 | VTL | T310 expiry before measurement report triggered |
| F1 | VTL | T310 expiry before measurement report received |
| F2 | VTL | RLC measurement report transmission error |
| F3 | TL | T310 expiry before HO command transmission |
| F4 | TL | T310 expiry before HO command reception |
| F5 | TE | T304 expiry |
| F6 | VTE | T310 expiry before HO confirm received |
| F7 | TE | RLC HO confirm transmission error |

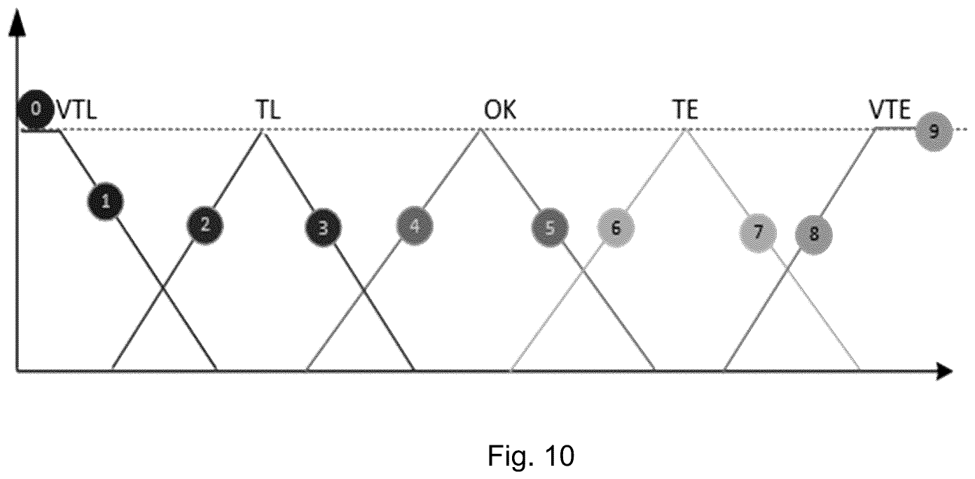

Membership functions (MFs) can then be defined as binary memberships or fuzzy memberships. The optimizer may decide to use the binary membership, meaning that each event is classified into a single set. The membership value can be either ‘0’ or ‘1’. The counter for each set is a cumulative integer counter. For the fuzzy memberships the optimizer can define MFs to define the membership of an event to a set. FIG. 10 presents an example for the MFs. The timers and event sequences can be used in addition to additional information in UE reports and network side.

Before explaining the application of fuzzy logic to the handover report a brief explanation of the general principles of use thereof is given as a short introduction to the concept of systems based on use of fuzzy logic and neural networks. Fuzzy logic can be used as a tool for reasoning propositions that can be manipulated with mathematical precepts where a proposition is a declarative or linguistic statement within a universe of discourse. A fuzzy logic can be understood as a transition from absolute truth to partial truth, expressed as from a variable x (True or False) to a linguistic variable, e.g., ‘almost true’, ‘Very close to true’, etc. That is, truths can be partial or approximate and any falseness can be represented by a partial truth.

A fuzzy set (e.g., A in X) is characterized by a membership function (MF) μ_A (x) which associates with each point in X a real number in the interval [0,1], with the values of μ_A (x) at x representing the grade of membership of x in A. The class of objects A belongs to X with a continuum of grades of membership μ_A (x). For example, a fuzzy set A={x_1, x_2, x_3, x_4} in X is characterized by the MF μ_A (x) which maps each point x in X to real values 0.5, 1, 0.75, and 0.5. μ_A (x) represents the degree of membership of x in A and the mapping is only limited by μ_A (x) inline [0,1]. Real-world situations are not certain and cannot be described precisely. The uncertainties of expressions like ‘very nice’, ‘too small’, ‘high value’ are commonly called fuzziness. The membership function (MF) characterizes the fuzziness of the fuzzy set A in X, which associates each point in X with a real number in the interval [0,1]. An MF can be defined in various manners, and the choice of an appropriate MF can be problem-dependent and is often determined heuristically and subjectively. The most widely used MFs in the fuzzy logic literature are triangular, trapezoidal, Gaussian, and bell-shaped functions.

Fuzzification is a process that allows converting a numeric value (or crisp value) into a fuzzy input. Fuzzification can be provided by singleton fuzzification which maps a real value xᵢ inline X into a fuzzy singleton Aₓᵢ which has membership value 1 at x=xᵢ and 0 at all other points in X. Singleton fuzzification greatly simplifies computation but is generally used in implementations where there is no noise. Another fuzzification method is where Aₓᵢ is fuzzy. This maps a realxi EX into a fuzzy set Aₓᵢ in X described by an MF. Thus fuzzification provides a membership grade of a real (or crisp) value xi @ X as its belongingness to a fuzzy set Aₓᵢ.

Defuzzification is the reverse process of fuzzification. Mathematically, the defuzzification of a fuzzy set is the process of conversion of a fuzzy quantity into a crisp value and can be used when a crisp value is to be provided from a fuzzy system.

Inference mechanism is used in a process of formulating a nonlinear mapping from a given input space to output space. The mapping then provides a basis from which decisions can be made. The process of fuzzy inference can involve the MFs, operators and if-then rules. Common types of fuzzy inference mechanisms are Mamdani fuzzy inference, Sugeno fuzzy inference, and Tsukamoto fuzzy inference. The differences between these fuzzy inferences, also called fuzzy models, mainly lie in the consequent parts of their fuzzy rules, aggregations and defuzzification procedures.

Turning now to an example in relation to handovers where appropriate MFs using the qualitative information available in RLFs and HO reports are used. While the concepts (i.e., using the defined information elements in the report) stays almost the same, variation of these functions may be defined dynamically by the optimizer. An example of these with reference to the different events shown in FIG. 10 is given below.
0. T310 expires or beam failure recovery (BFR) fails before UE is in A3 entry condition (TTT timer was not counting),

$${μ}_{vtl} = 1$$

where μᵥₜₗ is VTL MF.
1. T310 expires or BFR fails when UE is in A3 entry condition (TTT timer was counting),

$${μ}_{vtl} = 1 - \frac{TTT - {t}_{TTT}}{TTT + {t}_{a}}$$

where:
   TTT value defined by network,
   t_{TTT} the value remained on the timer before expiry, and
   tₐ: maximum admission control delay (set by network).
2. T310 expires or BFR fails after measurement report is sent.

$${μ}_{vtl} = 1 - \frac{Δ {t}_{1}}{TTT + {t}_{a}} , {μ}_{tl} = \frac{Δ {t}_{1}}{{t}_{a}}$$

where Δt₁ is the time difference between sending report and T310 expiry/BFR failure.
3. T310 expires due to failing HO command transmission.

$${μ}_{tl} = 1 - \frac{{N}_{RTR}}{{N}_{RTR}^{max}}$$

where:
   μₜₗ: TL MF
   N_{RTR}: number of retransmissions,
   N_{RTR}^{max}: maximum number of retransmissions
4. Successful connection reestablishment (HARQ) OR T310/BFR running in CHO leading to successful HO

$${μ}_{ok} = 1 - \frac{{N}_{RR}}{{N}_{RR}^{max}} OR {μ}_{ok} = 1 - \frac{{t}_{T 310}}{T 310}$$

where:
   μₒₖ: OK MF,
   t_{T310}: remaining values on T310 timer
   T310: the value of T310 timer (initial value set by network),
5. successful HO after multiple RACH attempts (T304 running),

$${μ}_{ok} = 1 - \frac{{N}_{RACH}}{{N}_{RACH}^{max}}$$

where:
   N_{RACH}: number of RACH attempts before connection reestablishment,
   N_{RACH}^{max}: maximum allowed number of RACH attempts
6. Successful HO, then T310 runs and stops (no failure), the connection remains with the target cell,

$${μ}_{ok} = 1 - \frac{{t}_{T 310}}{T 310}$$

7. T304 expires after multiple RACH attempts, UE reestablishes on Target Cell.

$${μ}_{te} = 1 - \frac{Δ {t}_{2}}{{t}_{te}}$$

where:
   Δt₂: the interval between T304 expiry and re-establishment,
   tₜₑ: maximum value for considering TE, set by network,
   μₜₑ: TE MF,
8. After successful HO, T310 expires and UE reconnect to the source cell

$${μ}_{vte} = 1 - \frac{Δ {t}_{3}}{{t}_{vte}}$$

where:
   Δt₂: the interval between T304 expiry and re-establishment,
   tₜₑ: maximum value for considering TE, set by the network.
   μᵥₜₑ: VTE MF,
9. T304 expires after multiple RACH attempts, UE reestablish on source Cell

$${μ}_{vte} = 1$$

The HO-related events information using the mapping table and MFs can be aggregated and reported to the optimizer function. The optimizer function can use the aggregated information and optimize the HO parameters, for example the CIO. A variety of algorithms can be used for optimization. Some algorithms are mentioned in the following as example use-cases where the aggregated information of HO events is used.

In accordance with an example 1 the optimizer function can use the number of events in each of the counters to decide to increase or decrease the CIO for the baseline HO. Below is an example for pseudo-code for an MRO algorithm, which can use the new fuzzy KPIs to decide.

```
if failures > fₜₕ and Nₑᵥₑₙₜₛ > Eₜₕ
  if TL + VTL + Hyps₁ > TE + VTE
    if TL + Hyps_{TL} > VTL
      increase CIO with small step
    else
      increase CIO with big step
  elseif TE + VTE + Hyps₁ > TL + VTL
    if TE + Hyps_{TE} > VTE
      decrease CIO with small step
    else
      decrease CIO with big step
elseif PP_{optmization} enabled and Nₑᵥₑₙₜₛ > Eₜₕ
  if PP + Hyps_{TE} > VPP
      decrease CIO with small step
    else
      decrease CIO with big step
```

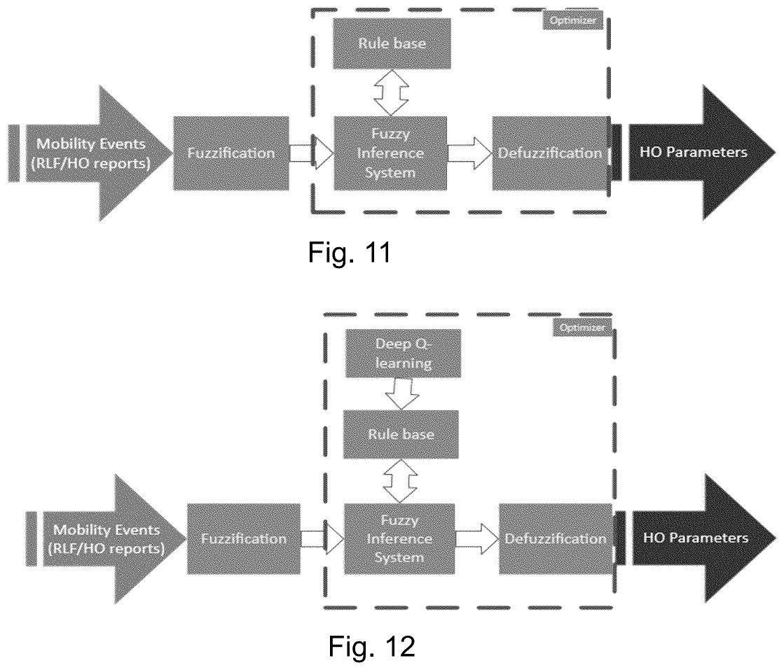

In another example the mobility optimizer can be a rule-based fuzzy optimizer as is shown in FIG. 11. The fuzzy optimizer takes the fuzzified mobility inputs and uses a rule-based fuzzy inference system to decide on the fuzzy outputs. The defuzzification block converts the fuzzy HO parameters to crisp logic parameters.

In yet another example the optimizer can be a Deep Reinforcement Learning (DRL) fuzzy optimizer, as it is shown in FIG. 12. The DRL fuzzy optimizer can learn the rules by experimenting.

The HO parameters can be updated by the optimizer based on the results and reported to the gNBs.

The process can be iterative and the steps repeated.

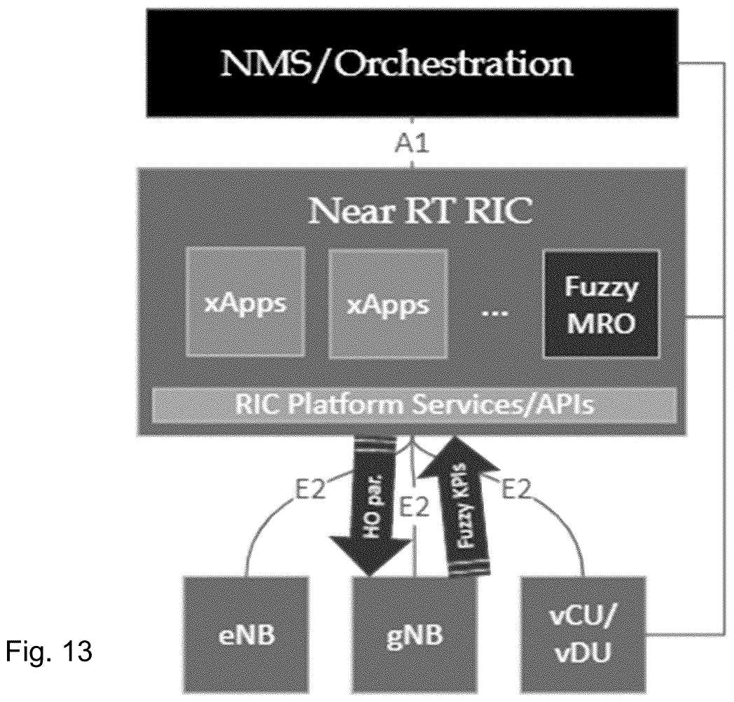

Information exchange between the gNBs and the optimizer may be realized in various manners. For example, an internal interface may be configured. This is relatively easy and requires no standardization. E2 interface defined in the ORAN specifications, see FIG. 13, may be adapted for this. O1 interface defined in ONAP may be used for the information. Other examples include Itf-N interface defined in LTE specifications, OAM interface as standardized by SA5, or based on the principles of service-based architectures.

The examples can provide qualitative mobility performance feedback which enables Self-Organizing Network (SON) MRO or machine learning-based mobility optimization algorithms to converge efficiently, avoiding local optima and being able to converge even in a fast-changing mobility environment.

It is noted that while the above describes example embodiments, there are several variations and modifications which may be made to the disclosed solution without departing from the scope of the present invention. Different features from different embodiments may be combined.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively or additionally some embodiments may be implemented using circuitry. The circuitry may be configured to perform one or more of the functions and/or method procedures previously described. That circuitry may be provided in the network entity and/or in the communications device and/or a server and/or a device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause the communications device and/or device and/or server and/or network entity to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

It is noted that whilst embodiments have been described in relation to certain architectures, similar principles can be applied to other systems. Therefore, although certain embodiments were described above by way of example with reference to certain exemplifying architectures for wireless networks, technologies standards, and protocols, the herein described features may be applied to any other suitable forms of systems, architectures and devices than those illustrated and described in detail in the above examples. It is also noted that different combinations of different embodiments are possible. It is also noted herein that while the above describes exemplifying embodiments, there are several variations and modifications which may be made to the disclosed solution without departing from the spirit and scope of the present invention.

1.-27. (canceled)

28. An apparatus for handover control in a mobile communication system, the apparatus comprising at least one processor and at least one memory including a computer program code, the at least one memory and computer program code configured to, with the at least one processor, cause the apparatus at least to:
receive handover information reports from user equipment,
generate a qualitative handover information report for input to a handover optimizer function, the generating comprising mapping failure cause information in the received handover information reports to sets of qualified failure types based on the extend of the failure causes, and
send the qualitative handover information report comprising information of the generated sets of qualified failure types to the handover optimizer function.

29. The apparatus according to claim 28, wherein the sets of qualified failure types are at least one of:
categorize the failure causes into at least one of:
too late and very too late handover initiations, and/or
too early and very too early handover initiations, and/or
ping-pong and long ping-pong handovers, or
defined for inter random access network handover types and intra random access network handover types.

30. The apparatus according to claim 28, wherein the handover information at least one of:
reports further comprise information of successful handovers;
reports from the user equipment comprise radio link failure reports and successful handover reports; and/or
reports comprise information of key performance indicators.

31. The apparatus according to claim 28, configured to dynamically change the mapping of failure cause information to sets of qualified failure types over time.

32. The apparatus according to claim 28, configured to use fuzzy membership functions for the mapping, wherein the membership functions are defined by the optimizer function.

33. The apparatus according to claim 32, wherein the optimizer function at least one of:
provides multiple sets of memberships functions;
is configured to update the memberships functions; and/or
comprises a rule based fuzzy optimizer or a deep reinforcement learning fuzzy optimizer.

34. The apparatus according to claim 32, wherein at least one of:
root-cause analysis and fuzzification is provided in at least one base station and the qualitative handover information report comprising information of the sets of qualified failure types is signaled from the at least one base station into the handover optimizer function,
root-cause analysis, fuzzification and optimization are provided by the optimizer function; and/or
the optimizer function is hosted in a base station.

35. An apparatus for a handover optimizer function in a mobile communication system, the apparatus comprising at least one processor and at least one memory including a computer program code, the at least one memory and computer program code configured to, with the at least one processor, cause the apparatus at least to:
receive a qualitative handover information report comprising aggregated information of sets of qualified failure types mapped from handover information reports from user equipment based on the extend of failure causes, and
control at least one handover parameter based on the aggregated information of the sets of qualified failure types.

36. The apparatus according to claim 35, wherein the sets of qualified failure types at least one of:
categorize the failure causes into:
too late and very too late handover initiations, and/or
too early and very too early handover initiations, and/or
ping-pong and long ping-pong handovers, and/or
are defined for inter random access network handover types and intra random access network handover types.

37. The apparatus according to claim 35, wherein the handover information at least one of:
reports further comprise information of successful handovers;
reports from the user equipment comprise radio link failure reports and successful handover reports; or
reports comprise information of key performance indicators.

38. The apparatus according to claim 35, configured to dynamically change the mapping of failure cause information to sets of qualified failure types over time.

39. The apparatus according to claim 35, configured to use fuzzy membership functions for the mapping, wherein the membership functions are defined by the optimizer function

40. A method for handover control in a mobile communication system, the method comprising:
receiving handover information reports from user equipment,
generating a qualitative handover information report for input to a handover optimizer function, the generating comprising mapping failure cause information in the received handover information reports to sets of qualified failure types based on the extend of the failure causes, and
sending the generated qualitative handover information report comprising information of the sets of qualified failure types to the handover optimizer function.

41. The method according to claim 40, wherein the sets of qualified failure types categorize the failure causes into at least:
too late and very too late handover initiations, and/or
too early and very too early handover initiations, and/or
ping-pong and long ping-pong handovers.

42. The method according to claim 40, wherein the handover information reports comprise at least one of: information of successful handovers, radio link failure reports, and/or information of key performance indicators.

43. The method according to claim 40, further comprising dynamically changing the mapping of failure cause information to sets of qualified failure types over time.

44. The method according to claim 40, further comprising fuzzification of the cause information by membership functions, wherein the membership functions are defined by the optimizer function.

45. The method according to claim 40, further comprising the optimizer function at least one of providing multiple sets of memberships functions, updating the memberships functions, and/or providing root-cause analysis, fuzzification and optimization.

46. The method according to claim 40, further comprising a base station providing root-cause analysis and fuzzification of the received handover information and signaling of the qualitative handover information report comprising information of the sets of qualified failure types to the handover optimizer function.

47. The method according to claim 40, further comprising a rule based fuzzy optimization or a deep reinforcement learning fuzzy optimization.
